(19) United States
(12) Patent Application Publication
(10) Pub. No.: US 2003/0009898 A1
(43) Pub. Date: Jan. 16, 2003

(54) Characterization of compliant structure force-displacement behavior

(75) Inventors: Alexander H. Slocum, Bow, NH (US); Jin Qiu, Cambridge, MA (US); Joachim Sihler, Somerville, MA (US); Roger S. Cortesi, Washington, DC (US); Micah D. Smith, Rawlings, MD (US); Jian Li, Cambridge, MA (US); Eun Suk Suh, Cambridge, MA (US); Shorya Awtar, Brighton, MA (US)

Correspondence Address: Theresa A. Lober, T.A. Lober Patent Services, 45 Walden Street, Concord, MA, 01742, US

(73) Assignee: Massachusetts Institute of Technology, Cambridge, MA (US)

(21) Appl. No.: 10/052,726

(22) Filed: Jan. 18, 2002

Related U.S. Application Data
(60) Provisional application No. 60/292,966, filed on Jan. 19, 2001.

(51) Int. Cl. G01D 21/00

(52) U.S. Cl. 33/706

(57) ABSTRACT

An instrument for enabling a precise determination of the force-displacement characteristics of a compliant structure, including both in-plane and out-of-plane structure deflection, is provided by the invention. The instrument includes a fixture that is oriented for constraining an end of the compliant structure with respect to mechanical ground as the force-displacement characteristic is determined. A mechanical probe of the instrument is disposed relative to the fixture to enable pushing of the probe against a free end of the compliant structure. A mechanical stage is provided, including a support for the probe, and being free with respect to mechanical ground to advance the probe relative to the fixture. This enables pushing of the probe against the free end of the compliant structure. A reference element is connected to the stage, and a displacement transmission element is disposed relative to the mechanical probe and the compliant reference element to transmit deflection of the compliant structure, produced by pushing of the probe, to the compliant reference element. A displacement sensor is disposed relative to the displacement transmission element to measure displacement of the transmission element, and a displacement sensor is disposed relative to the mechanical stage to measure displacement of the mechanical stage. The compliant reference element and the displacement transmission element can be configured with respect to the constraining fixture to accommodate deflection of the compliant structure along more than one axis, e.g., along either of two deflection axes.

### RELATED APPLICATION

This application claims priority to U.S. patent application Ser. No. 60/292,966, filed Jan. 19, 2001, the entirety of which is hereby incorporated by reference.

### BACKGROUND OF THE INVENTION

This invention relates to the characterization of microstructure operation, and more particularly relates to techniques for measuring quasi-static force-displacement characteristics of microstructures.

Micron-sized structures, or microstructures, are increasingly employed for a wide range of applications requiring mechanical motion in the micron regime. Microelectromechanical systems (MEMs), including, e.g., microactuators and microsensors, rely on microstructures to enable transduction or sensing of microscale parameters.

For many MEMs and other microscale systems, manufacture of system componentry is often most preferably accomplished through microelectronic fabrication processes and with microelectronic materials. Silicon is now widely acknowledged as an excellent mechanical as well as electrical material. As a result, Microsystems having integrated mechanical and electrical componentry can be efficiently microfabricated of silicon and other microelectronic materials, typically with dimensional precision not generally achievable with conventional macroscale, manual assembly techniques. Microfabrication provides further advantages as well, e.g., the efficiency drawn from its batch processing nature, and the ability to pattern mechanical as well as electrical componentry with lithographic processes.

While microfabrication processes are in general quite precise, most fabrication processes are characterized by some degree of unavoidable process variation, both across a single process batch and from process run to run. This is due to, e.g., drifting of process machine parameters and calibration, changes in process chemical purity and composition, changes in substrate material quality, and other variables. For example, plasma etch processes, which are commonly employed for etching mechanical microstructure geometry, can produce slightly differing results from etch to etch and from substrate to substrate. In addition, some mechanical features that inherently are produced by a microfabrication process can be undesirable for a given application.

For example, the plasma etch process of reactive ion etching, frequently employed to etch the geometry of microscale mechanical componentry, can produce undesirable mechanical features. Such etching, particularly when carried out through substantially the entire thickness of a silicon substrate, can produce slightly tapered, rather than vertical, sidewalls on a component being etched, with this taper varying from etch to etch; other features inherently due to the etch characteristics can also be produced. As a result, uniformity of the geometry of a reactive ion etched component cannot be guaranteed across a batch of components or from batch to batch.

It is found in practice that such variations in geometric uniformity act to vary the operational characteristics of mechanical components in a microstructure system. For example, mechanical flexural suspensions, which are very commonly employed for enabling microactuator movement, are characterized by operational parameters that are extremely sensitive to geometric variation. The stiffness of a flexural suspension is directly dependent on the moment of inertia of the suspension, which varies with the third power of the suspension's cross sectional width. Any unspecified variation in cross sectional width of a suspension, due, e.g., to a variation in sidewall tapering, thereby results in a shift in suspension stiffness, and a corresponding shift in operational performance.

For many microstructure applications, the precision in operational control required by the application cannot accommodate operational variations such as those produced in flexural suspensions by changes in suspension sidewall taper. Post-fabrication performance measurements of microstructures are therefore typically carried out for quality control, system adjustment and calibration, and design feedback. For moveable microstructures, such as, e.g., flexural suspensions, such measurements typically include determination of the force-displacement characteristics of the microstructures.

There has been proposed a wide range of techniques for determining the static force-displacement, or stiffness, of a deflectable microstructure. Such techniques typically require mechanical probing of the structure to ascertain the structure's response. Frequently these probe-based techniques make an assumption of very high rigidity of the probe in contact with the structure to be measured, because the parasitic deflection of the probe tip is not generally specifically accounted for in the microstructure displacement measurement. The provision of a sufficiently rigid probe tip is usually not a problem for an out-of-plane stiffness measurement because the area above a substrate on which the structure is provided is generally easily accessible and can accommodate a relatively large and rigid probe apparatus.

In contrast, to make an in-plane stiffness test, or force-displacement determination of a structure that deflects in the plane of a substrate, the probe employed to contact the structure must be sufficiently thin that the probe can be positioned adjacent to the structure, in the often very limited space between structures across the plane of a substrate. But the compliance of a relatively thin, needle-like probe can be on the same order as the microstructure itself and therefore, no assumption of probe rigidity can be relied on. As a result, conventional force-displacement measurement methods, which do not account for probe tip compliance, cannot be adopted for in-plane stiffness measurements of microstructures.

Even if the probe tip compliance of a conventional force-displacement instrument could be accounted for, it is found that in general, conventional force-displacement instrumentation cannot accurately directly represent microstructure in-plane deflection; it is not conventionally possible, as a practical matter, to directly make deflection measurements with conventional displacement sensors. In addition, microstructures typically are characterized by a relatively large compliance and correspondingly small force. But instrumentation designed for characterization of macrostructures generally is optimized for structures with relatively small compliance and correspondingly large force. As a result, conventional, large-scale characterization instrumentation generally cannot resolve and/or detect the small displacements of microstructures at the plane of their location.

Considering alternatives to conventional probe-based characterization techniques, material-property metrology tools such as nano-indenters, hardness testers, or scratch testers are often employed where conventional probe-based measurement techniques are not applicable. In such alternative techniques, a force is applied to a probe by, e.g., a magnetic coil, with a structure's displacement due to the force then being measured. But due to a characteristic mechanical instability, flexible microstructures, such as bistable devices, that exhibit an operational regime of negative stiffness cannot be continuously characterized with such instruments; the instrument lose mechanical contact with the device when an operational regime of negatively-sloped force-displacement dependence is encountered during the characterization process.

Alternative measurement techniques, such as dynamic measurement techniques, have been proposed for determining the natural frequency of a microstructure in order to calculate the static stiffness of the structure. Such techniques require accurate knowledge of the mass distribution of the structure and thus are accurate only for simple flexural structures that can be modeled as lumped-parameter systems. In addition, it is found that such techniques determine only a stiffness constant, as opposed to a complete force-displacement characteristic over the entire range of structural motion, which is often nonlinear.

Given the many limitations of the various measurement techniques described above, it has historically not been possible, as a practical matter, to make precise measurements of the force-displacement characteristics of a flexible microstructure, particularly when the deflection axis of the structure is in the plane of a substrate on which the structure is fabricated.

### SUMMARY OF THE INVENTION

The invention provides techniques, and corresponding apparatus, that enable highly precise determination of the force-displacement characteristics of a compliant structure, including both in-plane and out-of-plane structure deflection. An instrument for enabling such, as provided by the invention, includes a fixture that is oriented for constraining an end of the compliant structure with respect to mechanical ground as the force-displacement characteristic is determined. A mechanical probe of the instrument is disposed relative to the fixture to enable pushing of the probe against a free end of the compliant structure. A mechanical stage is provided, including a support for the probe, and being free with respect to mechanical ground to advance the probe relative to the fixture. This enables pushing of the probe against the free end of the compliant structure. A reference element is connected to the stage, and a displacement transmission element is disposed relative to the mechanical probe and the compliant reference element to transmit deflection of the compliant structure, produced by pushing of the probe, to the compliant reference element. A displacement sensor is disposed relative to the displacement transmission element to measure displacement of the transmission element, and a displacement sensor is disposed relative to the mechanical stage to measure displacement of the mechanical stage. The compliant reference element and the displacement transmission element can be configured with respect to the constraining fixture to accommodate deflection of the compliant structure along more than one axis, e.g., along either of two deflection axes.

With this configuration, the instrument of the invention enables force-displacement characterization of a wide range of compliant structures, including microstructures having dimensions and force regimes that are generally quite difficult to measure with conventional, macro-sized measurement equipment. The transmission of structure deflection from the structure to the reference structure overcomes the limitations of conventional instruments to enable such.

In accordance with the invention, the displacement transmission element can be provided as an amplification element. Here the amplification element is configured with respect to the mechanical probe to produce an amplification element displacement that is amplified with respect to deflection of the compliant structure. The amplification element can be embodied as, e.g., a lever arm, or other selected configuration. Whether or not the transmission element is implemented as a amplification element, the transmission element can be disposed orthogonal to an axis of the compliant structure deflection.

In one example configuration, the compliant structure is provided in a plane of a substrate, and deflection of the compliant structure is in the plane of the substrate. Here it can be preferred to provide the transmission element in a configuration orthogonal to the plane of the compliant structure substrate. The constraining fixture can be implemented in a wide range of configurations, e.g., as a substrate holder, such as a wafer holder. This is particularly advantageous for applications in which the compliant structure substrate is a microelectronic material substrate, such as a silicon substrate.

The force-displacement characterization technique and instrument of the invention is applicable to a wide range of compliant structures, and particularly microstructures such as those micromachined for MEMs. Other features and advantages of the invention will be apparent from the following description, and from the claims.

### BRIEF DESCRIPTION OF THE DRAWINGS

The invention will now be described with reference to the accompanying drawings, in which:

FIG. 1 is a schematic representation of the functional componentry of a system provided in accordance with the invention for determining the force-displacement characteristics of a microstructure;

FIG. 2 is a perspective view of an example instrument provided by the invention for determining the force-displacement characteristics of a microstructure in a selected degree of freedom of the microstructure;

FIG. 3 is a schematic representation of the operational parameters of the instrument of FIG. 2;

FIGS. 4A, 4B, and 4C are views of components of the instrument of FIG. 2 employed in calibration of the instrument;

FIG. 5 is a captured screen view of a control program implemented in accordance with the invention for carrying out a measurement configuration like that of FIG. 3;

FIG. 6 is a perspective view of an example instrument provided by the invention for determining the force-displacement characteristics of a microstructure in either of two degrees of freedom of the microstructure;

FIG.7 is a perspective detail view of the probe head of the instrument of FIG. 6; and

FIGS. 8A-8B are views of the sensor configuration of the instrument of FIG. 6, under a condition of purely vertical displacement and under a condition of displacement including bending, respectively.

### DETAILED DESCRIPTION OF THE INVENTION

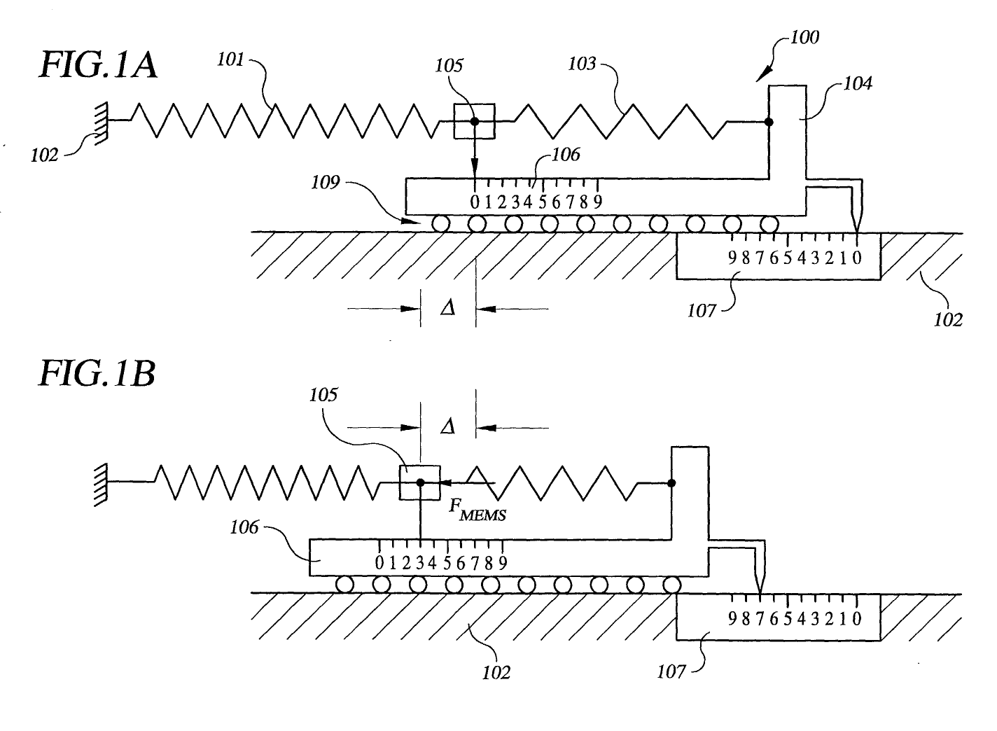

Referring to FIGS. 1A-B, there is shown a schematic view of the components of the force-displacement measurement instrument 100 provided by the invention. The unknown force-displacement characteristic of a compliant microstructure 101, here generally modeled as a spring for clarity of discussion, is to be determined. One end of the microstructure 101 is clamped, i.e., held fixed, with respect to mechanical ground 102. A compliant reference structure 103, having well-characterized properties of interest, is provided in a configuration that enables delivery of a displacement through the reference structure 103 to the microstructure 101. The reference structure 103 need not be positioned along the axis of the microstructure as shown in the figure; e.g., the reference structure can be offset from the microstructure.

Between the reference structure and the microstructure under characterization is provided a displacement transmission element 105. The mechanical displacement transmission element need not be provided in line with the axis of the microstructure, and similarly, the compliant reference structure need not be provided in line with the displacement transmission element; all three elements can be offset from each other in a suitable configuration. In addition, as illustrated in the example implementations described below, one or more intermediate structures, e.g., a probe tip, can be provided between the microstructure under characterization and the displacement transmission element, between the transmission element and the reference structure, or both.

The compliant reference structure 103 is attached to and carried by a moveable stage, here represented as slider 104 that can move relative to mechanical ground 102 by a suitable mechanism 109, here represented as rollers only for clarity in illustration of the degree of freedom provided to the slider 104. The slider is preferably characterized by linear error motion that is sufficiently low so as to not negatively affect the microstructure under test by transverse motion. The reference structure, in its configuration on the slider, is fully characterized and calibrated for its the force-displacement dependency, to enable determination of that of the microstructure in the manner described below.

Referring to FIG. 1B, measurement of the microstructure's force-displacement characteristic is carried out in accordance with the invention by first displacing the slider 104 with respect to mechanical ground 102. The resulting displacement of a point corresponding to the reference structure, e.g., the displacement transmission point 105, with respect to the slider 104 is recorded by a first displacement sensor 106 that can be provided integral with or separate from the slider. The displacement of the slider 104 with respect to ground 102 is similarly recorded, here with a second displacement sensor 107 that can be provided integral with the mechanical ground region or as a separate element. For clarity, both displacement sensors are depicted here as line scales, but such is not required by the invention.

The displacement of the microstructure under test is determined by subtracting the measurement of the first displacement sensor 106 from that of the second displacement sensor 107, taking into account the displacement transmission element's transmission ratio. In one embodiment of the invention that can be preferred for many applications, the displacement of the microstructure under test is amplified by the displacement transmission element, here operating as an amplification element; this amplification enables determination and resolution of even relatively small displacements, and their corresponding forces, which are characteristic of microstructures.

Thus, in accordance with the invention, based on the displacement measurements and based on any amplification factor introduced by the displacement transmission element, the force, F_{MEMS}, of the microstructure, corresponding to the microstructure displacement, is obtained based on the previously recorded calibration data of the compliant reference structure, in the manner described below. Although the schematic representations of FIGS. 1A-B indicate transmission of the microstructure displacement to a reference structure through the transmission element along a common axis, this is for clarity of discussion only. As explained in detail below, a particular advantage of the instrument of the invention is its ability to accommodate a configuration that transfers local microstructure deflection to a non-local position where conventional, macro-sized sensors can be provided.

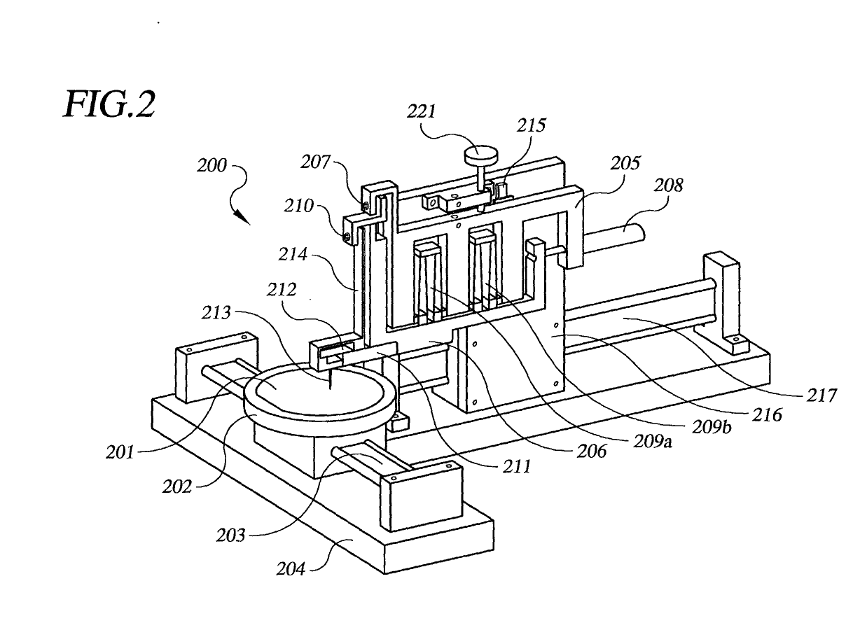

Considering first an example implementation of the characterization instrument the invention, in FIG. 2 there is shown an instrument 200 enabling measurement of the force displacement characteristic of a microstructure that is provided in a plane, e.g., on a substrate such as a silicon wafer. The substrate 201 including the microstructures to be measured is supported by a substrate holder 202, e.g. by a vacuum chuck or other selected technique. The substrate is preferably very rigidly clamped to its holder to maintain mechanical clamping of the microstructure; any movement of the substrate during measurement of microstructure deflection could introduce errors into the measurement. A vacuum chuck is found to be particularly effective at maintaining this clamped condition.

The substrate holder 202 is attached to a linear motion stage 203, which is in turn attached to a mechanically-fixed base plate 204 defining mechanical ground. The linear motion stage 203 thereby defines a linear X-axis of motion. The main body 205 of the instrument includes a moving frame 206, an upper displacement sensor 207, such as e.g., an optical displacement sensor, and a micrometer displacement screw 208. The moving frame 206 is supported relative to the main body 205 by a compliant structure, e.g., folded-beam flexural bearings 209a and 209b, which ensure accurate linear motion of the moving frame 206 with respect to the main body 205. The moving frame also includes a lower displacement sensor 210 which like the upper sensor can be provided as an optical sensor. One example suitable implementation of the upper and lower sensors is, e.g., the HP1500 optical sensor from Agilent, Inc., Palo Alto, Calif.

A probe head 211 is provided attached to the moving frame 206. The probe head 211 consists of a compliant reference flexure 212, a probe 213, and a displacement transmission element, here configured as an amplification element, a lever arm 214. The probe is preferably provided in a shape and configuration that enables good accessibility, e.g., optical accessibility, to the microstructures to be characterized on the substrate. The point of contact of the probe tip is preferably well-defined to ensure that the actual tip, and not a point along the shaft of the probe, contacts a microstructure, thereby ensuring that effective force leverage is delivered by the probe. The probe can be tilted in its configuration on the probe head to enable such. Alternatively, the very tip of the probe can be bent so that the tip is the first point of contact made when positioning the tip in proximity to a microstructure.

In operation, the main body 205 can be moved up and down by linear bearings 215 actuated by a corresponding screw 221, defining a Z-axis of motion, to bring the tip of the probe 213 to a level with respect to the substrate 201 that enables testing of microstructures on the substrate. The main body 205, including the slider bearings 215, is attached to a handle plate 216, which is in turn attached to the linear motion stage 217, defining a Y-axis of motion. With this connection, X-axis, Y-axis, and Z-axis motion can be employed to coarsely locate the tip of the probe 213 relatively close to a microstructure before a measurement is carried out.

Once the probe tip is thusly positioned, the three motion stages are locked in place. Thereafter, the flexural bearings 209a, 209b are engaged, by setting of the micrometer displacement screw 208, to incrementally advance the tip of the probe 213 in a desired displacement. It is to be recognized that any suitable 3-axis positioning configuration can be employed to enable coarse positioning of the probe relative to the microstructure. Whatever configuration is employed, it preferably enables locking of each of the axes of motion as explained above.

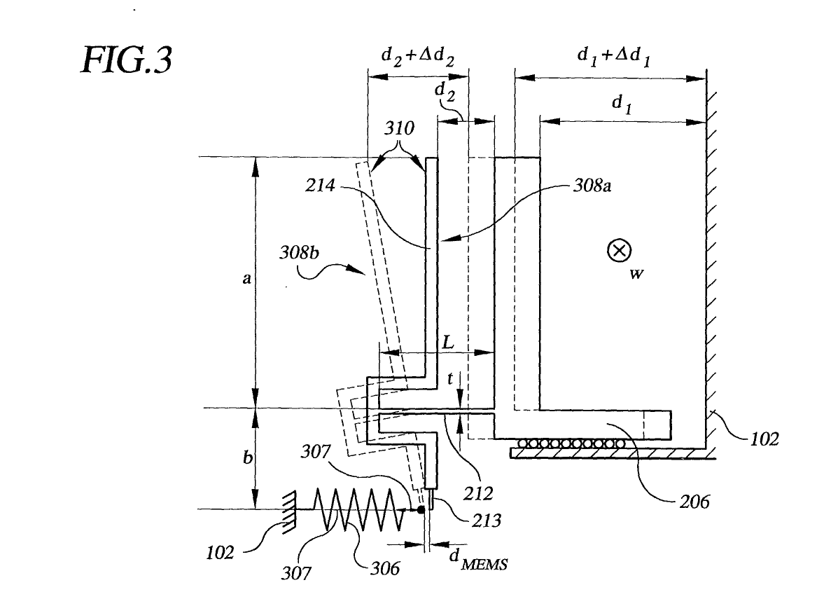

FIG. 3 provides a schematic representation of component movement of the instrument of FIG. 2, illustrating the principal of force-displacement determination provided by the invention. The moving frame 206 can move in a straight line with respect to mechanical ground, here the base plate 204. The displacement of the moving frame 206 is indicated as Δd₁ and in operation is recorded by the appropriate displacement sensor 207, 210 (FIG. 2). Attached to the moving frame 206 is the calibrated compliant reference flexure 212. Attached to the reference flexure is the probe 213 as well as the amplification lever 214.

Initially, the probe tip is in contact with a compliant target microstructure 306, shown in FIG. 3 as a spring, and the lever arm as-connected to the reference flexure structure is in an undisplaced position 308a. The moving frame 206 is then displaced, causing the reference flexure structure 212 to deform and the lever arm to be correspondingly displaced in a manner given by the dashed line, to a displacement position 308b. This rotation of the amplification lever arm 214 in turn causes a displacement at the tip 310 of the lever. This lever arm tip displacement, Δd₂, is recorded by the displacement sensors.

With this amplification lever arm action, the invention enables a geometrical amplification of the measured displacement, thereby to enhance the resolution and low-end range of the measurement technique. If an amplification mechanism like that of FIGS. 2-3 is employed, then with respect to the moving frame, displacement at the tip of the probe 213 is geometrically amplified roughly by the ratio a/b, where a is the upper arm length and b is the lower arm length as given in FIG. 3.

It is to be recognized that the particular amplification element shown in the figures is not required by the invention; any suitable configuration that enables amplification of displacement can be employed. If the transmission element does not amplify displacement, then no amplification factor need be considered in the displacement measurements. In addition to displacement amplification, the lever arm enables transmission of the microstructure deflection from the microscale substrate plane to the macroscale reference flexure structure. Thus even very small in-plane deflections of the microstructure can be detected and measured by the instrument by employing conventional displacement sensors.

Turning back to the force-displacement determination, the deformation of the reference flexure 212 by displacement of the moving frame 206 exerts a force 307 on the microstructure under test 306, and vice versa; i.e., the displacement of the microstructure by the probe tip exerts a force on the reference flexure. This force deflects the microstructure 306 by a displacement given as d_{MEMS}. The magnitude of the displacement d_{MEMS} is in general a function of the difference between the moving frame displacement, Δd₁, and the lever arm tip displacement, Δd₂. To accurately make this determination of the displacement magnitude d_{MEMS}, the amplification of the lever arm tip displacement, Δd₂, as well as characteristic parasitic bending of the probe 213 expected to occur during testing is accounted for in a calibration procedure that is also carried out to produce the reference force-displacement function employed to determine the force-displacement characteristics of the microstructure under test. After the calibration process, force-displacement determinations made by the instrument accurately reflect the impact of the probe compliance, and therefore accurately reflect the microstructure's compliance.

The calibration of the measurement instrument of the invention is based on the understanding that the application of a force to multiple linear springs provided in series generates the same force in each of the springs. Given that the instrument arrangement provides a microstructure under characterization, the probe, and the referenced structure in mechanical series, then calibration of the instrument for the compliance of the system enables a determination of the compliance of a microstructure under test. The total compliance of the instrument, K_{212,213}, here represented as a spring constant, includes the compliance of the reference structure 212 and the compliance of the probe 213. Prior to calibration, this instrument compliance is unknown.

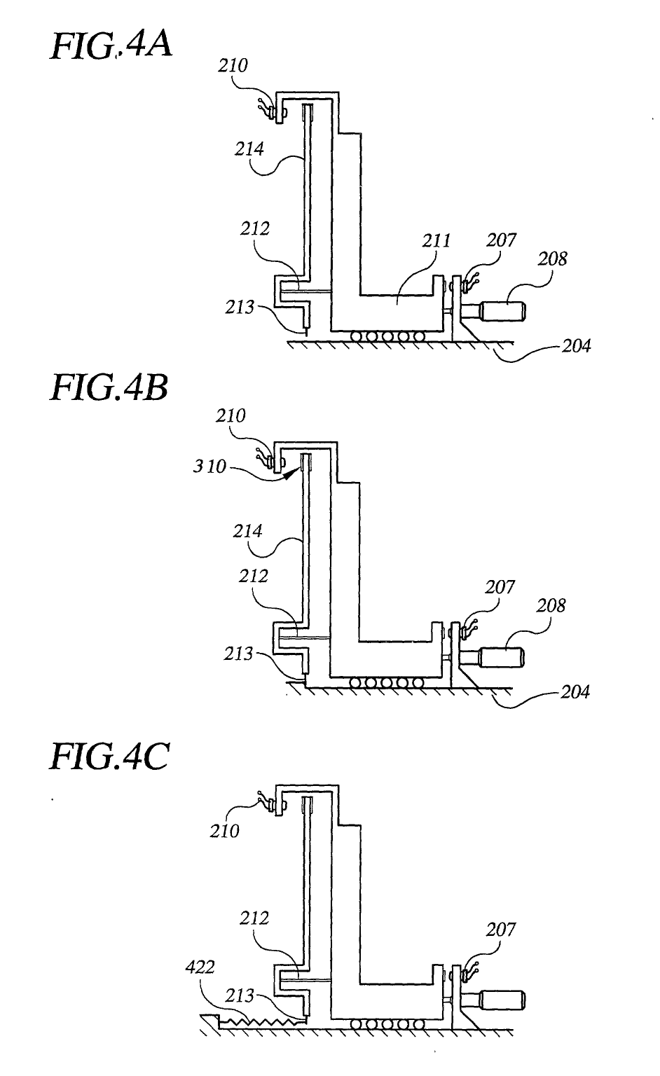

Referring to FIG. 4A, to begin the calibration process, the upper displacement sensor 207 is calibrated. To enable such, the probe head 211 is configured with the upper displacement sensor 207 and the micrometer 208 provided thereon. The reference structure 212, probe 213, and amplification lever arm 214 are configured on the probe head as they would be during test. In the first calibration step, the output of the upper displacement sensor 207 is calibrated, as Δd₁, with the movement of the moving frame 206, here represented by the movement of the probe head. This is done by moving the probe head 211 with the micrometer 208 in selected increments. Here the probe head is free to move with respect to mechanical ground.

For each micrometer increment, the output from the micrometer is read and entered into a table with the corresponding voltage output from the sensor 207. Because the sensor output may not be linear, a table is preferably used to record all the data. Interpolation can then later be employed to convert sensor voltage output values to corresponding displacement values, e.g., in mm. A high-precision micrometer is thus preferably here employed, implemented as, e.g., a 0.0001-inch resolution Starret micrometer, and the increment of calibrated displacement is preferably as small as practical, e.g., about 1 μm. The calibration table can be provided in any convenient form, e.g., a look-up table stored in computer memory, or other convenient configuration.

Referring to FIG. 4B, in the second calibration step, the lower displacement sensor 210 is calibrated for the displacement of the probe 213 with respect to the moving frame 211, as amplified through the lever arm tip 310. Here the probe is mechanically fixed with respect to ground, e.g., by pushing against a rigid object. In this step, the micrometer 208 is incrementally adjusted in the manner described above. At each increment, the output from both the upper and lower sensors 207, 210 is monitored.

The data for a given incremental position is interpreted as follows. The output value from the upper sensor 207 is converted to a corresponding displacement value by the calibration data from the first step. The output of the lower displacement sensor 210 corresponds to the deflection of the probe, given as Δd₂(b/a), and the deflection of the lever arm, given as Δd₂. Because the probe is here held fixed, the probe displacement relative to the frame 211 is here actually numerically equal to the displacement indicated by the upper sensor 207. This calibration step therefore makes a correspondence between the output of the second displacement sensor 210 and the mechanical displacement of the probe, Δd₂(b/a), with respect to the moving frame 211. Thus, as a result of the first and second calibration steps, both Δd₁ and Δd₂ are accurately calibrated for the output values of the two displacement sensors.

In a third and final calibration step, the instrument compliance K_{212,213}, defined above, is determined. Referring to FIG. 4C, in a first method for accomplishing this, a known reference spring 422 is provided in a position to be pushed against by the probe 213. Such a reference spring 422, i.e., a structure having a known compliance, can be obtained, e.g., from the national Institute of Standards and Technology as a Standard reference material (SRM), or a spring can be made and its mass measured, and then it can be excited and its natural frequency measured and used to determine its stiffness. For either implementation, the reference spring is assumed to be provided with a known reference spring constant, K_{known}, against which the probe can push.

In this configuration, the reference spring, the probe, and the reference structure are connected in a mechanical series configuration, and hence the force in each of these elements is equal as the configuration is displaced. As the micrometer is advanced, the outputs of the upper and lower displacement sensors 207, 210 identify corresponding displacements, Δd₁, and Δd₂, through the calibration table produced by the earlier steps. This enables a determination of the displacement of the known spring structure, d_{known}, as d_{known}=Δd₁−(b/a)Δd₂. Then, the force that is applied on all of the known spring, probe, and reference structure, because the elements are in series, is given as F=k_{known}d_{known}. The displacement across the instrument compliance K_{212,213} is measured to be (b/a) Δd₂ and the product of this displacement with the instrument compliance K_{212,213} will therefore also be equal to the force. Hence the instrument compliance can be determined as K_{221,213}=(K_{known}d_{known})/((b/a)Δd₂). The invention contemplates the use of a calibrated force sensor instead of a known reference spring, for making this last calibration step. Here the force can be measured directly from the force sensor, whereby the instrument compliance is then given as K_{212,213}=Fₘₑₐₛᵤᵣₑ/(b/a)Δd₂). An example implementation of such a force sensor can employ, e.g., the DPS-11 force sensor from Imada, Inc.

The instrument compliance calibration data as a function of the displacement sensors output is added to the calibration table for enabling a determination of microstructure force produced by the Δd₁ and Δd₂ values produced the by displacement sensors as a microstructure is tested. Specifically, the compliance of the microstructure, K_{MEMS}, is given as:

K_{MEMS}=K_{212,213}((b/a)Δd₂)/d_{MEMS}; (1)

and the corresponding force of the microstructure, F_{MEMS} is then given as:

F_{MEMS}=K_{212,213}((b/a)Δd₂) (2)

Thus, the calibration table is completed by providing a column of possible microstructure force values corresponding to the tabulated displacement sensor readings, and a column of possible compliance values can also be included, if desired, corresponding to the displacement sensors' outputs. Preferably, this last calibration step is carried out at relatively small increments. It is recognized that each calibration step produces discrete, rather than continuous data values. With the calibration table complete, it can therefore be preferable for many applications to employ an interpolation technique, e.g., a linear interpolation technique, to provide a continuous calibration data function. This can be very efficiently carried out in software in the conventional manner.

With the calibration complete, characterization of a microstructure can be carried out. With the tip of the probe engaged to push against a deflectable, compliant microstructure, the micrometer of the instrument is adjusted to move the moving frame 206 and to correspondingly move the probe head 211. The point of engagement between the tip of the probe and the microstructure can be easily detected by monitoring the lower displacement sensor 210, which indicates deflection of the tip of the lever arm. As soon as displacement of the lever arm is found to occur, mechanical contact between the probe and the microstructure is guaranteed to have been established.

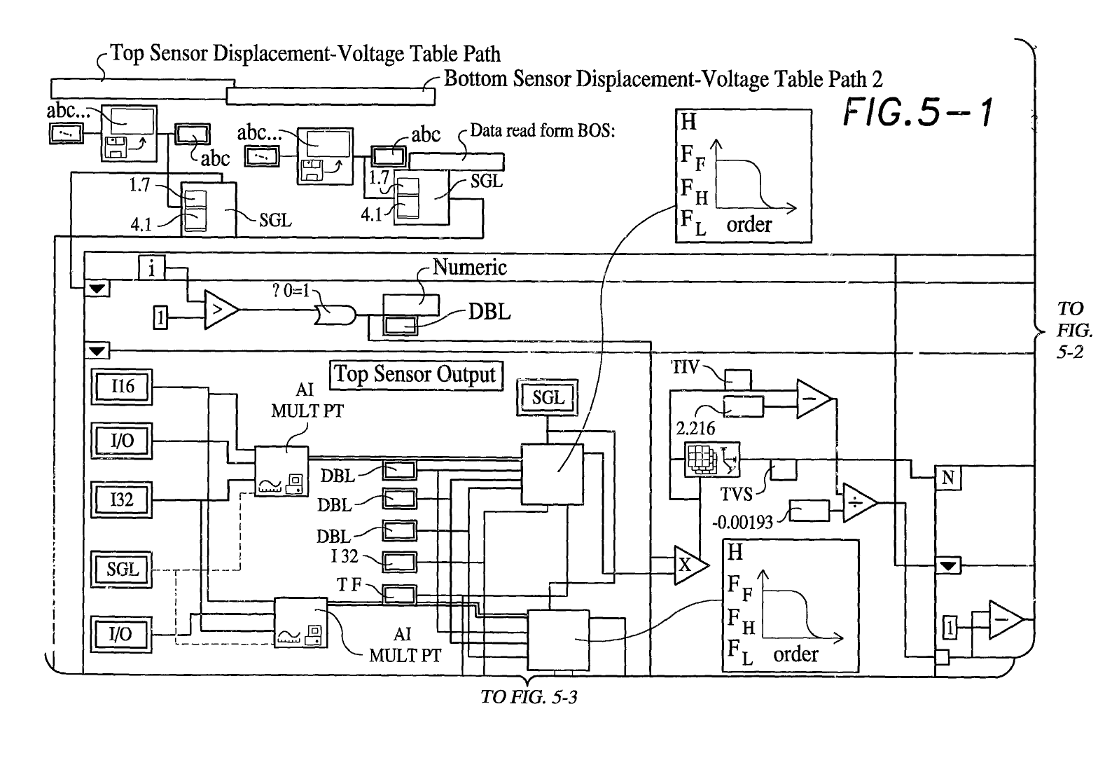

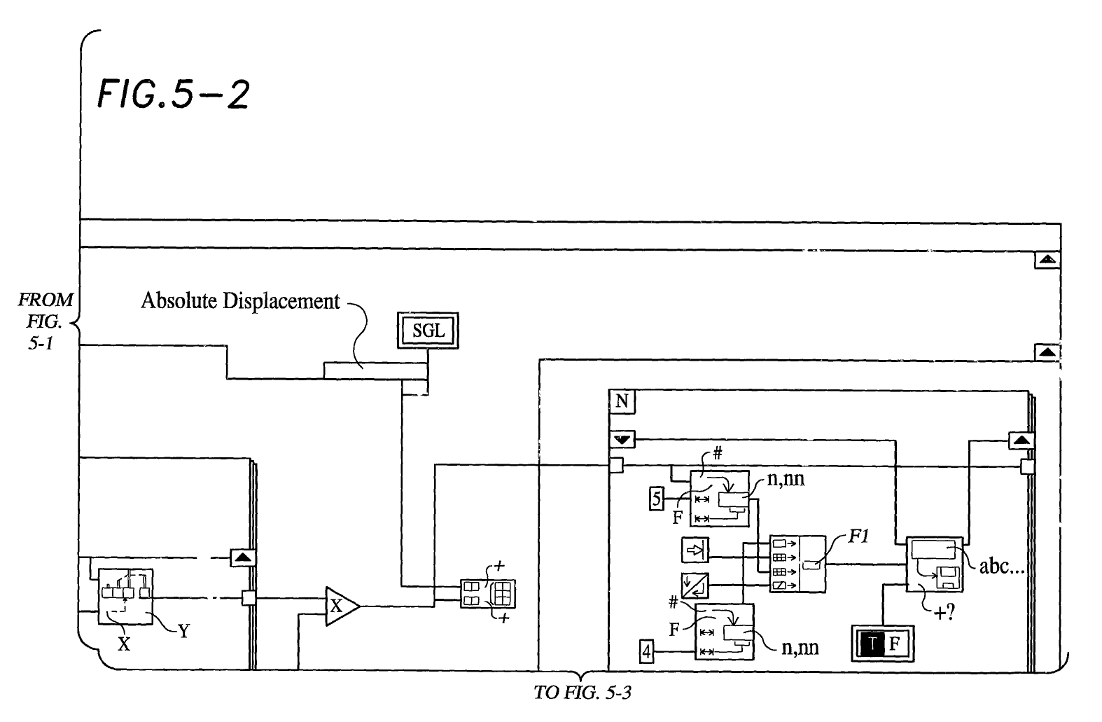

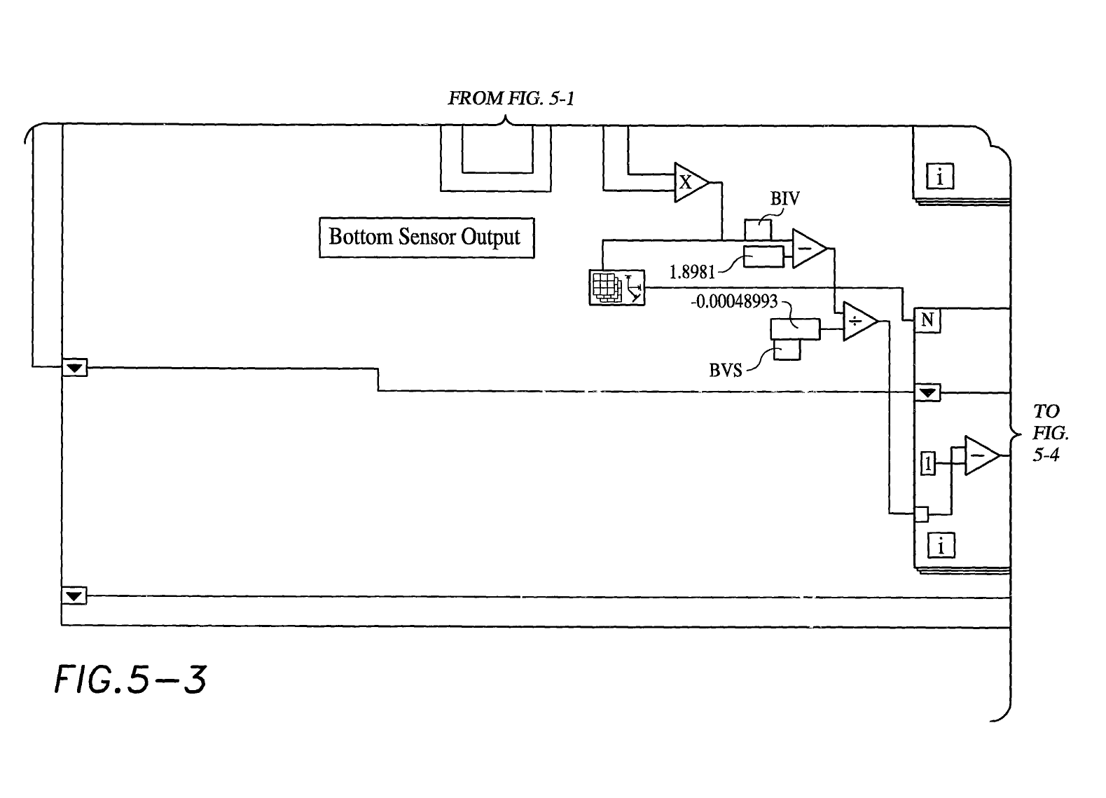

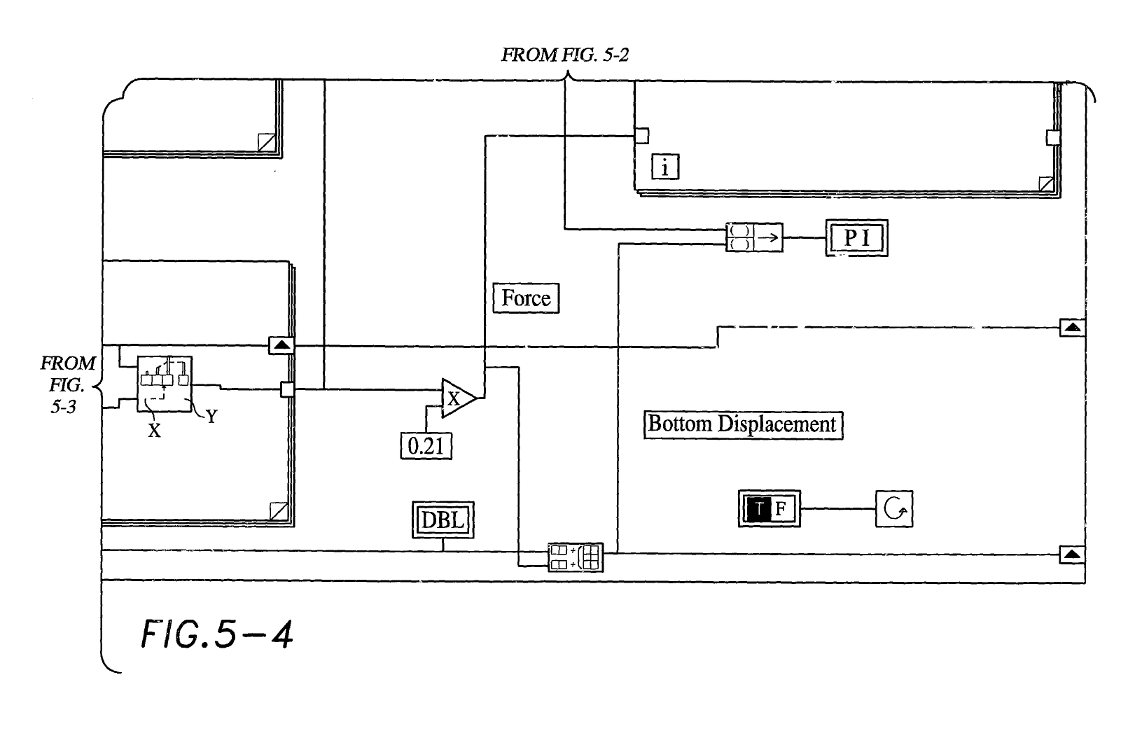

In carrying out the characterization of a microstructure, the micrometer is slowly advanced, e.g., at about 3 revolutions per minute. During the corresponding advancement of the probe head, the output values of the upper and lower displacement sensors are monitored. This output monitoring can for many applications most efficiently be conducted automatically with, e.g., a conventional computer configuration. With the calibration table data stored in the computer, automatic generation of microstructure force data can be produced by the computer for a given microstructure displacement, and interpolation of the calibration data can be efficiently provided if necessary for a given application. Standard instrumentation software, e.g., LabVIEW, by National Instruments, Inc., can be employed to enable this automatic input/output functionality. FIG. 5 is a captured screen view of such an implementation of the measurement process employing the LabVIEW software.

The resulting force-displacement characteristic of the microstructure can further be plotted by the computer. The invention also contemplates integration of data acquisition and computation modules with the instrument, for enabling a stand-alone characterization system. If an automated technique cannot be accommodated, then appropriate manual monitoring of the displacement sensors is carried out for each in a series of incremental micrometer advances, with the data manually tabulated for subsequent force determination. In design of the characterization instrument of the invention, the reference flexure is designed based on the microstructure force, F_{MEMS}, and/or displacement range, d_{MEMS}, expected for a microstructure to be tested. The microstructure force, F_{MEMS}, is given as:

F_{MEMS}=Δd₂EI/abl; where I=bt³/12; (3)

where I is the polar moment of inertia of the reference flexure, a and b are the upper and lower lengths, respectively, of the amplification lever arm, ●d₂ is the displacement of the amplification lever tip, E is the Young's modulus of the reference flexure material, and l is the length of the reference flexure. The deflection of the microstructure, d_{MEMS}, specified as the displacement at the contact point between the probe tip and the microstructure, can be given as:

d_{MEMS}=Δd₁−b/aΔd₂; (4)

where Δd₁ is the displacement of the moving frame and probe head, and Δd₂ and the lever arm lengths a and b are as given above. With this design analysis, it is shown that by changing the geometry of the compliant reference structure 212, i.e., the thickness, t, or the length, L, of the reference structure, as indicated in FIG. 3, the instrument can be easily adjusted to cover a large range of microstructure compliance and deflection. It is to be recognized that if the displacement transmission element does not amplify the microstructures deflection, then no amplification factors are to be included in the above design equations.

Preferably the geometry of the compliant reference structure results in a structure having characteristics similar to a cantilever beam. The compliant reference structure can be provided as a folded crab flexure design similar to that of that of the flexures employed to hold the moving frame with respect to the main body. It is particularly preferable that the compliant reference structure exhibit linear motion, with low transverse error motion, to minimize unintentional transverse deflection of a microstructure being characterized. The displacement transmission element can be provided in any convenient configuration that enables transmission of the microstructure deflection from the plane of the substrate, or other structure, to a non-local position that enables measurement of the deflection more conveniently.

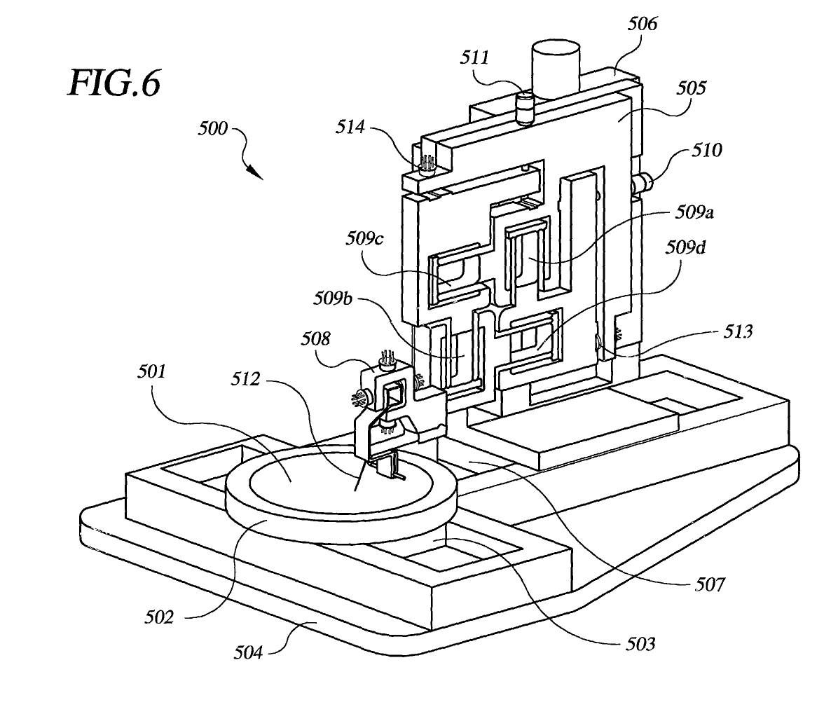

The invention contemplates a wide range of configurations of apparatus for enabling and expanding the test measurement techniques of the invention. For example, the measurement system of the invention can be adapted to enable two dimensional force-deflection characterization. An example of such an adaptation is shown in FIG. 6. Here the measurement instrument 500 is designed to take measurements for the force-displacement characteristic of a microstructure in two directions, e.g., in the plane of a substrate on which the microstructure is provided as well as out of plane of the substrate.

The substrate 501 that includes the target microstructure to be characterized is supported by a substrate holder 502 by vacuum or other configuration as in the apparatus of FIG. 2. The substrate holder 502 is mounted on a linear motion stage 503, the motion of which is defines a linear X-axis. The X-axis stage 503 is in turn mounted on a base plate 504 that defines mechanical ground. The main body 505 of the instrument is mounted on a first slider 506, the motion of which defines a linear Z-axis. The first slider 506 is also mounted on a second linear motion slider 507, the motion of which defines a linear Y-axis. This second slider 507 is also mounted to the base plate 504.

A probe head 508 is carried by the main body 505 in a configuration that enables exchange of probe heads customized for various measurement ranges. The main body 505 also includes a first number, e.g., two, of decoupled flexural bearings 509a-509b that guide the main body 505 in the Y-axis direction of motion and a second number, e.g., two, decoupled flexural bearings 509c-509d that guide the main body in the Z-axis direction of motion. The decoupled flexural bearings are driven by suitable adjustment mechanisms, e.g., micrometers 510 and 511, respectively.

A first displacement sensor 513 is provided for horizontal displacement measurements, i.e., measurements in the Y-axis direction, and a second displacement sensor 514 is provided for vertical displacement measurements, i.e., measurements in the Z-axis direction. As in the example instrument of FIG. 2 above, here the X-axis stage 503, the Y-axis slider 507, and the Z-axis slider 506 are together employed to coarsely position the tip of the probe 512 in the proximity of a microstructure to be characterized. Thereafter, the micrometer screws 510, 511 are adjusted in increments to acquire force deflection data for the microstructure in a manner analogous to the method described above.

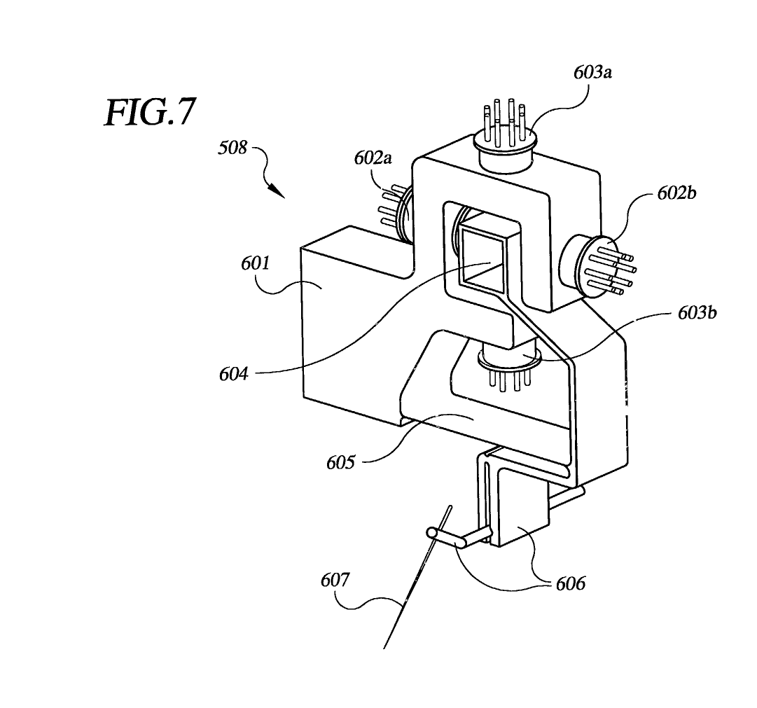

The particular function of the probe head 508 can be understood more fully with reference to FIG. 7, showing a detailed view of the probe head 508. Attached to the main body 601 of the probe head are provided two sensors 602a, 602b for making lateral displacement measurements, and two sensors 603a, 603b for making vertical displacement measurements. The sensors are preferably mounted in a differential configuration, e.g., as shown in the figure, for enabling enhanced common noise rejection. The sensors can be provided as any suitably type, e.g., as the optical sensors described above.

With this configuration of sensors, the displacement of a central cube structure 604, which is attached to the compliant reference structure 605, is determined. Also attached to the reference structure 605 is a holder 606 for holding the probe 607. The probe 607 is preferably mounted somewhat off-center with respect to the probe head 508 in order to allow more visual accessibility of the probe tip while the tip is being coarsely positioned in proximity to a microstructure to be characterized. Small asymmetric components of the reference structure deformation are accounted for in the calibration data, which is recorded with the probe in place in the manner described above. It is understood that moving the probe tip out of position, e.g., to replace the probe tip, requires the production of a new set of calibration data.

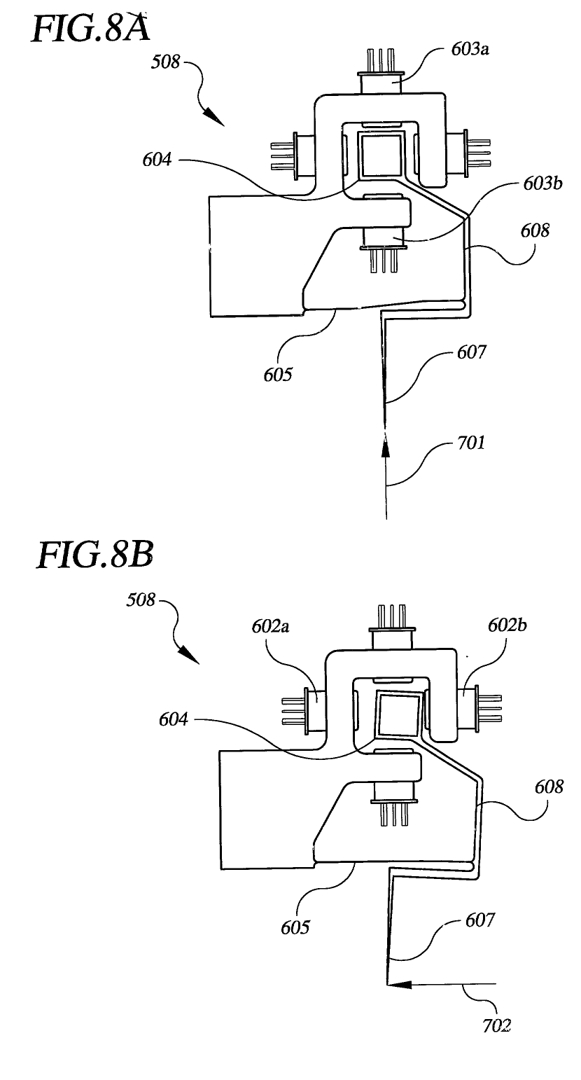

FIGS. 8A and 8B illustrate a front view of the probe head 508 of FIG. 7. In FIG. 8A the probe head is shown with a vertical force 701 acting on the probe 607. This causes bending of the compliant reference structure 605 and corresponding upward movement of the frame 608 of the probe head 508. As the frame moves upward the cube structure 604 likewise moves upward; here unlike the configuration employing a lever arm, the transmission of microstructure deflection is not amplified by the frame's movement. Because the line of movement is through the middle of the reference structure 605, this vertical motion is free of parasitic transverse error motion, which could cause harm to a microstructure, being under the force 701. The optical sensors 603a and 603b measure the vertical displacement of the probe tip for making one measurement of the characteristic. The advantage of the differential configuration is here clear; the two sensor readings, which are opposite in magnitude, can be added to reject common mode noise.

In FIG. 8B there is shown the application of a horizontal force 702 to the probe tip. Here the bending of the compliant reference structure 605 causes a slight rotation of the frame 608 of the probe head 508. The displacement of the probe is in this instance measured by the horizontal displacement of the cube structure 604 against the second pair of optical sensors 602a and 602b. Because in this case the leverage from the reference structure down to the probe is about the same as that from the reference structure to the cube, no appreciable amplification of microstructure displacement occurs as the displacement is transferred through the frame.

Note that the probe 607 itself will also bend under the load in this scenario. It is therefore to be understood that this bending should be accounted for during the calibration procedure in which a known displacement is imposed onto the probe and the sensor reading is mapped for a calibration table. The way in which the probe head functions and is calibrated within the entire instrument is analogous to that for the single degree of freedom system shown in FIGS. 4A-C.

The invention contemplates a wide range of alternatives for production of an instrument that enables the force-displacement characterization of the invention. For example, the main body, probe head, base plates, and stages of the instrument can be provided as aluminum sheet stock, cut, e.g., with a waterjet machining process. This fabrication technique is particularly advantageous in that it enables production of the compliant reference structures and associated configuration as a unitary structure; no assembly of flexures with another structure is here required. The main body of the instrument can also be produced of other materials having isotropic properties, such as metals or plastics. Whatever material is selected, it preferably does not exhibit creep under stress, i.e., true elastic deformation of the material is preferred.

The compliant reference structure preferably does not exhibit hysteresis, and thus is preferably fabricated of a material such as silicon or other selected material. If the probe head is to be fabricated of the compliant reference structure material, then it is preferred to not provide the probe head or the complaint reference structure out of aluminum, which can exhibit hysteresis. The amplification element can be produced of any suitable material that enables precise structural deflection in response to an applied force. The displacement transmission element can be produced of aluminum or other selected material that is compatible with a given application. For example, when produced of aluminum, the transmission element can be subjected to a magnetic field for damping vibrations of the element without effecting a DC displacement characterization process.

In another embodiment contemplated by the invention, the probe head, main body, and reference flexures of the instrument can be microfabricated as micromachined componentry. In this case, the probe tip, the compliant reference structure or structures, and the displacement sensors can be provided as monolithic structures formed of silicon or other microelectronic material. Monolithic displacement sensors can here be provided as, e.g., capacitive sensors or other sensors of convenience.

The force-displacement characterization technique of the invention and its associated instrument enable characterization of microstructures that cannot as a practical matter be characterized by conventional instruments that are optimized for macroscale forces. The instrument can be employed for characterizing compliant structures of any size regime, but is particularly well-adapted for characterization of microstructures, because displacement characterization in the plane of a substrate containing the microstructures, as well as orthogonal to the substrate, is enabled by the instrument of the invention. A wide range of microelectromechanical components and systems can therefore be efficiently and precisely characterized. It is recognized, of course, that those skilled in the art may make various modifications and additions to the characterization techniques and instruments described above without departing from the spirit and scope of the present contribution to the art. Accordingly, it is to be understood that the protection sought to be afforded hereby should be deemed to extend to the subject matter of the claims and all equivalents thereof fairly within the scope of the invention.

We claim:

1. An instrument for determining a force-displacement characteristic of a compliant structure, comprising:
a fixture oriented for constraining an end of the compliant structure with respect to mechanical ground as the force-displacement characteristic is determined;
a mechanical probe disposed relative to the fixture to enable pushing of the probe against a free end of the compliant structure;
a mechanical stage including a support for the probe and being free with respect to mechanical ground to advance the probe relative to the fixture, for pushing the probe against the free end of the compliant structure;
a compliant reference element connected to the stage;
a displacement transmission element disposed relative to the mechanical probe and the compliant reference element to transmit deflection of the compliant structure, produced by pushing of the probe, to the compliant reference element;
a displacement sensor disposed relative to the displacement transmission element to measure displacement of the transmission element; and
a displacement sensor disposed relative to the mechanical stage to measure displacement of the mechanical stage.

2. The instrument of claim 1 wherein the displacement transmission element comprises an amplification element configured with respect to the mechanical probe to produce an amplification element displacement that is amplified with respect to deflection of the compliant structure.

3. The instrument of claim 2 wherein the amplification element comprises a lever arm.

4. The instrument of claim 1 wherein the transmission element is disposed orthogonal to an axis of the compliant structure deflection.

5. The instrument of claim 1 wherein the compliant structure is provided in a plane of a substrate, deflection of the compliant structure being in the plane of the substrate.

6. The instrument of claim 5 wherein a plane of the transmission element is orthogonal to the plane of the compliant structure substrate.

7. The instrument of claim 5 wherein the constraining fixture comprises a substrate holder.

8. The instrument of claim 7 wherein the substrate holder comprises a wafer holder, and wherein the compliant structure substrate comprises a microelectronic material substrate.

9. The instrument of claim 8 wherein the compliant structure substrate comprises a silicon substrate.

10. The instrument of claim 1 wherein the compliant reference element and the displacement transmission element are configured with respect to the constraining fixture to accommodate deflection of the compliant structure along either of two deflection axes.
